(19) United States
(12) Patent Application Publication
(10) Pub. No.: US 2026/0072887 A1
(43) Pub. Date: Mar. 12, 2026

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventors: Kohei OGI, Kanagawa (JP); Masakazu FUJIKI, Kanagawa (JP)

(21) Appl. No.: 19/317,243

(22) Filed: Sep. 3, 2025

(30) Foreign Application Priority Data
Sep. 10, 2024 (JP) 2024-156834

(51) Int. Cl. G06F 16/215; G06F 40/253

(52) U.S. Cl. CPC G06F 16/215; G06F 40/253

(57) ABSTRACT

An information processing apparatus comprising: an acquisition unit configured to acquire generated data generated by using generative AI; an information acquisition unit configured to acquire generation condition information that is information indicating a generation condition when the generated data is generated; and a storage unit configured to store the generated data and the generation condition information in association with each other.

### BACKGROUND

### Field of the Technology

The present disclosure relates to an information processing apparatus, a method of controlling the information processing apparatus, and a storage medium.

### Description of the Related Art

In recent years, with the development of the AI technology, a technology called generative AI, which generates and alters various content by learning various data to generate a learning model and giving data serving as input has been developed. For example, image generation AI that generates a new image by inputting a text prompt (hereinafter, a prompt) to a model that has learned many images, and a technology that can chat as if having a conversation by inputting a prompt have also been developed. In addition, it is possible to summarize a long sentence, to generate a new text, and to generate an entirely new image from one image and another image.

It is possible to generate an image representing a person who does not exist from one image and another image and to generate a color image from the black-and-white image. In addition, it is possible to alter an image by inputting an image and a prompt. Furthermore, it is possible to generate various content by utilizing the generative AI, such as generating a moving image and an audio and generating a program code. When generating data using the generative AI, it is necessary to give the generative AI generation condition information such as a prompt, and the intent behind the data generation can entirely be ascertained by checking this generation condition information.

Here, there is a method of storing generated data in association with a condition regarding the generation. In Japanese Patent Laid-Open No. 2004-135941, an output photographing condition is stored linked with a photographed fundus oculi image.

### SUMMARY

The present disclosure provides a technology for reducing effort required for reference to generation condition information when generative AI performs generation.

According to one aspect of the present disclosure, there is provided an information processing apparatus comprising: an acquisition unit configured to acquire generated data generated by using generative AI; an information acquisition unit configured to acquire generation condition information that is information indicating a generation condition when the generated data is generated; and a storage unit configured to store the generated data and the generation condition information in association with each other.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view illustrating a hardware configuration example of an information processing apparatus that can achieve each embodiment.

FIG. 2 is a view illustrating a mechanism configuration example of an information processing apparatus that can achieve a first embodiment.

FIG. 3 is a flowchart showing a procedure of processing of storing generated data and generation condition information in association with each other in the first embodiment.

FIG. 4 is a view illustrating an example of a data structure when generation condition information is stored in the first embodiment.

FIG. 5 is a view illustrating a configuration example of an information processing apparatus that can achieve a second embodiment.

FIG. 6 is a flowchart showing a procedure of processing of regeneration of data in the second embodiment.

FIG. 7 is a view illustrating a configuration example of an information processing apparatus that can achieve a third embodiment.

FIG. 8 is a flowchart showing a procedure of processing of performing deletion of generated data in the third embodiment.

FIG. 9 is a view illustrating a configuration example of an information processing apparatus that can achieve a fourth embodiment.

FIG. 10 is a flowchart showing a procedure of processing of generating a generation history map from generation condition information in the fourth embodiment.

FIG. 11 is a view illustrating an example of a data structure when a generation history map is generated in the fourth embodiment.

FIG. 12 is a view illustrating a display example of a generation history map generated from a generation condition in the fourth embodiment.

FIGS. 13A to 13D are views illustrating an example of a UI of each embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

The present embodiment is a description of a technology that can reduce the effort required for reference to generation condition information associated with generated data. The generation condition information is information indicating a generation condition when generated data is generated. In the present embodiment, a case where an information processing apparatus according to the first embodiment is applied in a situation where image generation is performed using a diffusion model as generative AI will be described. In the image generation in the present embodiment, generation condition information is input to the diffusion model to output different images.

### Hardware Configuration

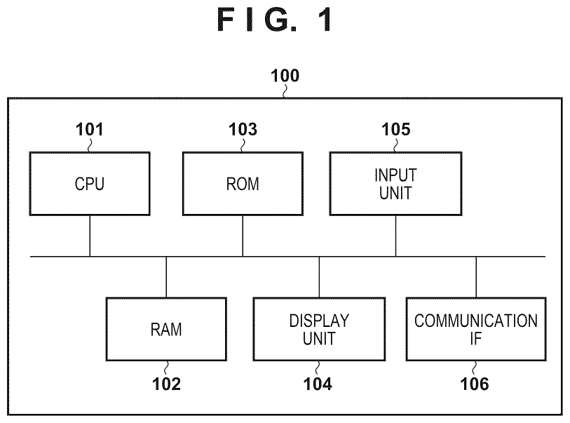

FIG. 1 illustrates a hardware configuration example of an information processing apparatus according to the present embodiment. An information processing apparatus 100 according to the present embodiment is a computer configured to include a CPU 101, a RAM 102, a ROM 103, a display unit 104, an input unit 105, and a communication IF 106. Note that each piece of hardware is configured to be able to communicate with each other, and connected by a bus or the like.

The CPU 101 executes a program stored in the ROM 103 and the like, and achieves a function of the information processing apparatus. The CPU 101 also performs display control by controlling the input unit 105. The RAM 102 stores acquired generated data and data to be displayed on the display unit 104. The RAM 102 has a storage capacity sufficient to store a predetermined number of still images and a moving image of a predetermined time. The RAM 102 also serves as an image display memory (video memory), and supplies display data to the display unit 104.

The ROM 103 is a storage device such as a magnetic storage apparatus or a semiconductor memory, and stores a program read based on the operation of the CPU 101, data that needs to be stored for a long time, and the like. The display unit 104 includes a liquid crystal display, and can display various data and processing results to the user.

The input unit 105 includes an input device such as a switch, a button, a key, a touch panel, and a keyboard, and receives an input from a user. An input through the input device is detected by the CPU 101 through the bus, and the CPU 101 controls each unit to achieve an operation according to the input.

### Functional Configuration

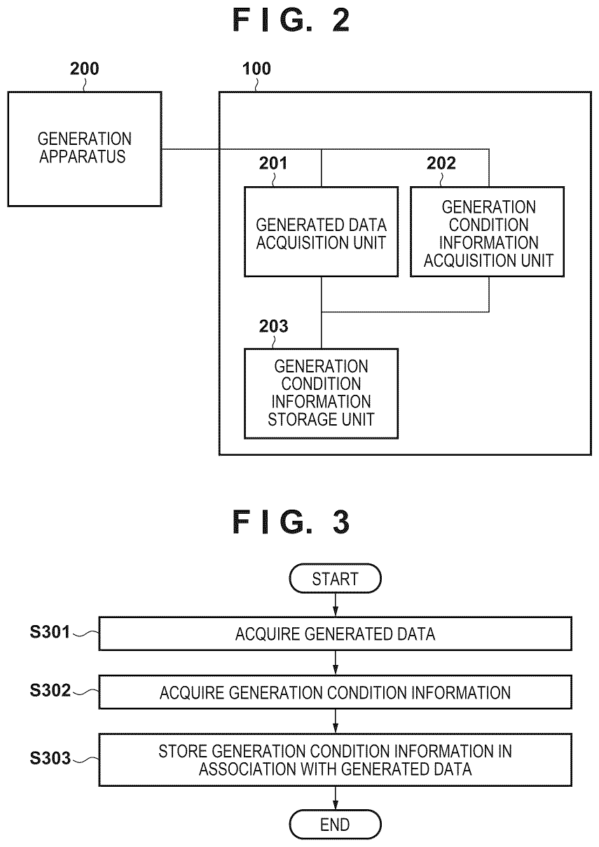

FIG. 2 is a view illustrating a functional configuration example of the information processing apparatus in the present embodiment. The information processing apparatus 100 of the present embodiment includes a generated data acquisition unit 201, a generation condition information acquisition unit 202, and a generation condition information storage unit 203. A generation apparatus 200 exists separately from the information processing apparatus 100, and generates an image using a diffusion model.

The generated data acquisition unit 201 acquires the image generated by the generation apparatus 200 from the generation apparatus 200 via the communication IF 106. The generation condition information acquisition unit 202 acquires, from the generation apparatus 200, the generation condition information when the generated image is generated. In the present embodiment, a prompt to be input to image generation AI and a noise initial value that is an initial value of random noise in image generation using the diffusion model are the generation condition information. The noise initial value is an initial value of a random number parameter given to the generative AI. The generation condition information can include at least one of a prompt, a negative prompt, a noise initial value, a CFG scale, a sampling method, a sampling step, and model identification information.

The generation condition information storage unit 203 stores, in the ROM 103, the generated image acquired by the generated data acquisition unit 201 and the generation condition information acquired by the generation condition information acquisition unit 202 in association with each other. Here, the noise initial value needs to be stored as one piece of the generation condition information because it is impossible to reproduce a same image unless the initial value of the random noise is known when it is desired to reproduce the same image. This is because the diffusion model has a mechanism of assigning one initial value of random noise at the time of image generation, and generating an image based on the initial value. Therefore, since the noise initial value is information essential for image reproduction, it is necessary to record it as generation condition information.

Each of these functional units is achieved by the CPU 101 developing, into the RAM 102, a program stored in the ROM 103, and executing processing according to each flowchart described later. Then, the execution result of each process is stored in the RAM 102.

### Processing

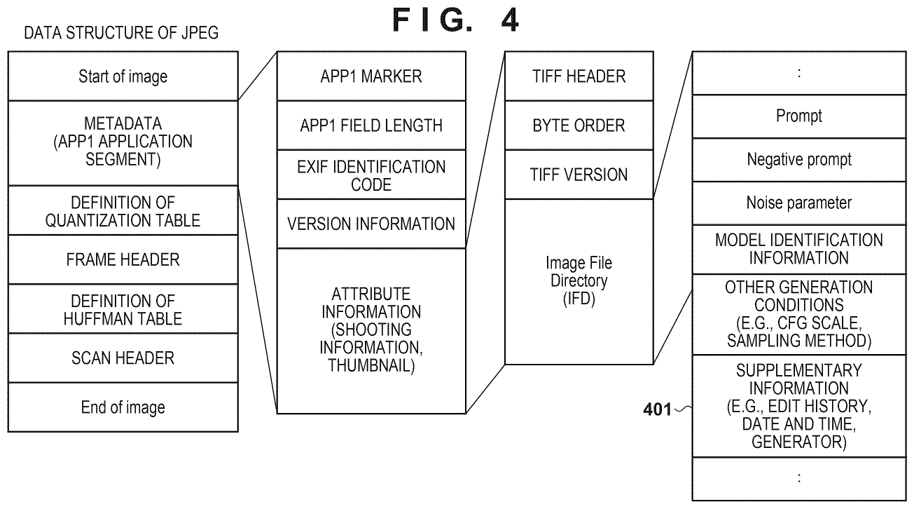

FIG. 3 is a flowchart showing a flow of processing of the information processing apparatus 100 in the present embodiment illustrated in the configuration diagram of FIG. 2. In step S301, the generated data acquisition unit 201 acquires, via the communication IF 106, the image generated by the generation apparatus 200. In step S302, the generation condition information acquisition unit 202 acquires, from the generation apparatus 200, the generation condition information used for image generation. In step S303, the generation condition information storage unit 203 stores the generation condition information in the ROM 103 in association with the generated image. The above is the series of processing in FIG. 3.

### Data Structure

FIG. 4 is an example of a data structure in a case where the generation condition information in the present embodiment is stored as Exif. In a predetermined data slot, a prompt, a negative prompt, a noise parameter (noise initial value), model identification information, other generation conditions, and the like are stored as generation condition information, and in addition, supplementary information 401 such as a generation date and time and a generator is also stored. Here, the stored generation condition information can be referred to at any timing. For example, there is a case of making reference for checking a generated situation, or making reference in a case where it is desired to perform image generation by diverting an identical generation condition or a partial generation condition.

In a case where image generation is performed by diverting a generation condition, a prompt or a noise initial value recorded in the generation condition information is input again to the image generation AI. By setting the input noise initial value as the initial value of random noise, a noise removal process (=image generation process) under the identical condition is executed, and the same generated image can be obtained.

### Effect

As described above, according to the present embodiment, the generated data and the generation condition information are stored in association with each other. Therefore, access to the generation condition information only requires referencing to predetermined data of Exif of the same file as the generated data, and it is possible to reduce the effort required for reference to the generation condition information.

### Modification: Neural Network Model Used in Generative AI

In the first embodiment, the generative AI is a diffusion model, but the present disclosure is not limited to this as long as it is an AI model that outputs data based on a generation condition. For example, a generative adversarial network (GAN) or a variational autoencoder (VAE) may be used. Flow-based generative models (Flow), a large language model (LLM), or the like may be used. Furthermore, image quality enhancement processing AI such as noise removal, super resolution, or debayer may be used.

By this, also in a case where the neural network model used for the generative AI is other than the diffusion model, it is possible to reduce the effort required for reference to the generation condition information corresponding to the generated image.

### Modification: Parameter of Generation Condition Information

In the first embodiment, the prompt and the noise initial value are mainly cited as the generation condition information, but the generation condition information is not limited to them as long as the information is related to the generation condition of the generative AI. For example, it may be a negative prompt, a CFG scale, a sampling method, a sampling step, model identification information, generation source data, mask data, or the like. The generation condition information may be one or a plurality of these types of generation condition information.

Furthermore, in step S303, not all types of generation condition information acquired from the generation apparatus 200 by the information processing apparatus 100 but some types of generation condition information may be stored. In a case where some types of generation condition information are stored, generation condition information of a predetermined type may be stored, or generation condition information of a type selected by the user of the information processing apparatus 100 may be stored.

This enables the user to refer to all the generation conditions associated with the generated image by accessing the generated image.

### Modification: Variation of Generation Apparatus

The first embodiment assumes that the generation apparatus 200 is an apparatus different from the information processing apparatus 100, but the information processing apparatus 100 may be configured to hold a generation unit (not illustrated) configured to generate an image based on generation condition information. Also in this case, the generated data acquisition unit 201 acquires the image generated by the generation unit, the generation condition information acquisition unit 202 acquires the generation condition information from the generation unit, and the generation condition information storage unit 203 stores the generated data and the generation condition information in association with each other.

Furthermore, in the first embodiment, the number of the generation apparatuses 200 is one, but may be two or more. Here, a case where there are a first generation apparatus (not illustrated) and a second generation apparatus (not illustrated) different from the information processing apparatus 100 will be described. Also in this case, similarly, the generated data acquisition unit 201 acquires images generated by the respective generation apparatuses, and the generation condition information acquisition unit 202 acquires the generation condition information from the first generation apparatus and the second generation apparatus. Then, the generation condition information storage unit 203 stores the data generated by the first generation apparatus or the data generated by the second generation apparatus in association with each piece of the generation condition information on a one-to-one basis. Furthermore, the same applies to a configuration in which the first generation apparatus is different from the information processing apparatus 100 and the information processing apparatus 100 holds a plurality of generation units.

By this, even in a case where the information processing apparatus 100 holds the generation unit or in a case where there is a plurality of generation apparatuses, the user does not need to perform switching processing of the generation apparatus, and only needs to perform necessary input only to the information processing apparatus 100.

### Modification: Storage Form

The first embodiment has a form in which the generation condition information and the generated data are stored in association with each other, but the following method may be used as long as the generated image and the generation condition information are associated on a one-to-one basis. For example, after the generation condition information is recorded in Exif, the generated image and Exif may be stored in the same file. That is, the generation condition information may be stored in an identical data file to the data file in which the generated data is stored.

Alternatively, in a case where the generated image is handled in a system such as a cloud or a server, the generated image and the generation condition information may be stored in different databases after being associated with each other on a one-to-one basis. That is, the generated data and the generation condition information may be linked with each other on another apparatus, and the generated data and the generation condition information may be stored in different databases.

This can reduce the effort required for reference to the generation condition information corresponding to the generated image in any storage form.

### Modification: Tamper Prevention

The first embodiment assumes a form in which the generated image and the generation condition information are stored in association with each other, but tamper prevention may be performed when they are stored. Known technologies for tamper prevention include a technical standard called C2PA for tamper prevention metadata that can be attached to digital content, and therefore this may be used.

This can reduce the possibility that the generated image data and the generation condition information stored by the user are maliciously rewritten by a third party.

### Second Embodiment

In the present embodiment, a method of regenerating an image using an update model in a case where an update occurs in a model used for image generation will be described. Regeneration is to acquire the generation condition information stored in association with a generated image, and apply exactly the same generation condition, or correct part or the entirety of the generation condition information to perform image generation. In the present embodiment, a method of performing regeneration using the same generation condition information as the generation condition information associated with the generated image will be described.

### Functional Configuration

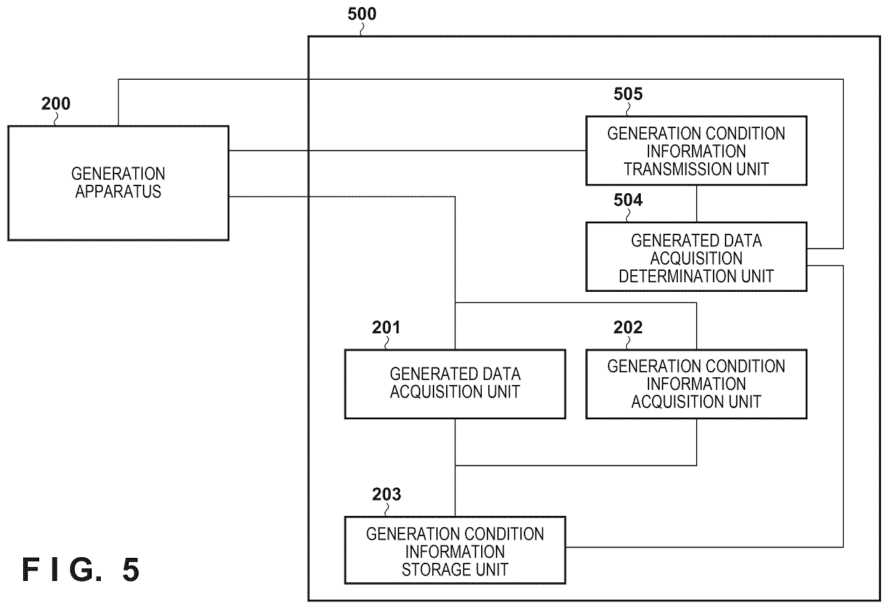

FIG. 5 is a view illustrating a functional configuration example of the information processing apparatus in the present embodiment. An information processing apparatus 500 includes the generated data acquisition unit 201, the generation condition information acquisition unit 202, the generation condition information storage unit 203, a generated data acquisition determination unit 504, and a generation condition information transmission unit 505. The same components as the components described in the first embodiment are denoted by identical reference signs, and the description thereof will be omitted.

The generated data acquisition determination unit 504 determines whether or not it is necessary to regenerate the generated data by referring to the generation condition information recorded in the generation condition information storage unit 203. In a case where the generated data acquisition determination unit 504 determines that it is necessary to acquire the generated image, the generation condition information transmission unit 505 transmits, via the communication IF 106, the generation condition information to the same generation apparatus as the generation apparatus used for target image generation.

### Processing

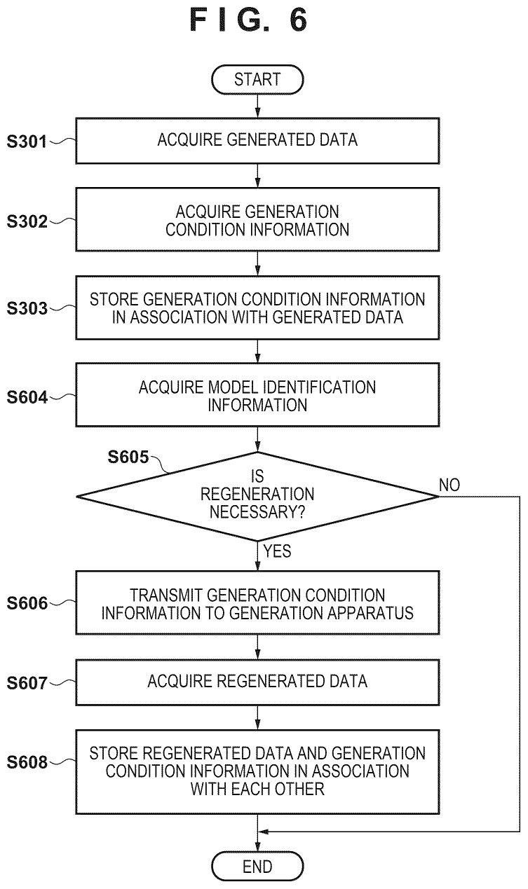

FIG. 6 is a flowchart showing a flow of processing of the information processing apparatus in the present embodiment illustrated in the configuration diagram of FIG. 5. Here, a method of regenerating an image and a method of acquiring a regenerated image will be described.

Steps S301 to S303 are omitted because they are similar to those in the first embodiment. In step S604, the generated data acquisition determination unit 504 acquires, for a specific generated image, model identification information recorded in the generation condition information of the generated image that has already been generated. Furthermore, the same model identification information as the acquired model identification information is acquired also from the generation apparatus 200.

In step S605, the generated data acquisition determination unit 504 determines, for the specific generated image, whether or not regeneration is necessary based on the generation condition used when the image generation is performed. That is, it is determined whether or not the generated data needs to be acquired again. For example, update information, creation date and time, and the like of the two models are compared based on the two pieces of model identification information acquired in step S604. In a case where the corresponding model is updated, the generated data acquisition determination unit 504 determines that regeneration is necessary. In a case where the present step is Yes, the process proceeds to step S606. In a case where the present step is No, on the other hand, the series of processing is ended.

In step S606, the generation condition information transmission unit 505 transmits, to the generation apparatus 200 via the communication IF 106, the generation condition information stored in the generation condition information storage unit 203.

Thereafter, the generation apparatus 200 generates an image by inputting the generation condition information received from the information processing apparatus 500 to the image generation AI held in the generation apparatus 200. In the present embodiment, since there is update content in the model identification information recorded in the generation condition information, the generation apparatus 200 performs regeneration using the updated model. The generation apparatus 200 transmits the regenerated image to the information processing apparatus 500 via the communication IF 106.

In step S607, the generated data acquisition unit 501 acquires the regenerated image data from the generation apparatus 200 via the communication IF 106. In step S608, the generation condition information storage unit 503 stores, in the ROM 103, the regenerated image data and the generation condition information in association with each other. This is the end of the series of processing in FIG. 6.

### Effect

As described above, according to the present embodiment, by regenerating the image data based on the generation condition information, it is possible to increase the possibility that the user generates image data with a different model while maintaining the intent of the user behind the image generation in the generation condition.

### Modification: Case Where Generation Apparatus at Time of Regeneration is Different From Source Reproduction Apparatus

In the second embodiment, the generation apparatus used when the source image is generated is used when regeneration is performed, but a different generation apparatus may be used. In a case where a generated image is acquired from the first generation apparatus, generation condition information may be transmitted to the second generation apparatus via the communication IF 106 during the regeneration, and the generated image regenerated by the second generation apparatus may be acquired from the second generation apparatus via the communication IF 106.

This enables the user to give the generation condition information to different generation apparatuses, and can increase the possibility of obtaining a desired image.

### Third Embodiment

The present embodiment is a description of a technology that reduces a use capacity of a storage by deleting generated image data while retaining only a link to generation condition information.

In image generation AI, since a large number of images can be generated at a time, a large number of generated images press the storage. Therefore, it is necessary to delete an image determined to be unnecessary for the user. At that time, generated image data is deleted while retaining only the link to the generation condition information so that the generated image data can be regenerated later.

In the present embodiment, an example of deleting generated image data that has not been used for a certain period of time or more will be described.

### Functional Configuration

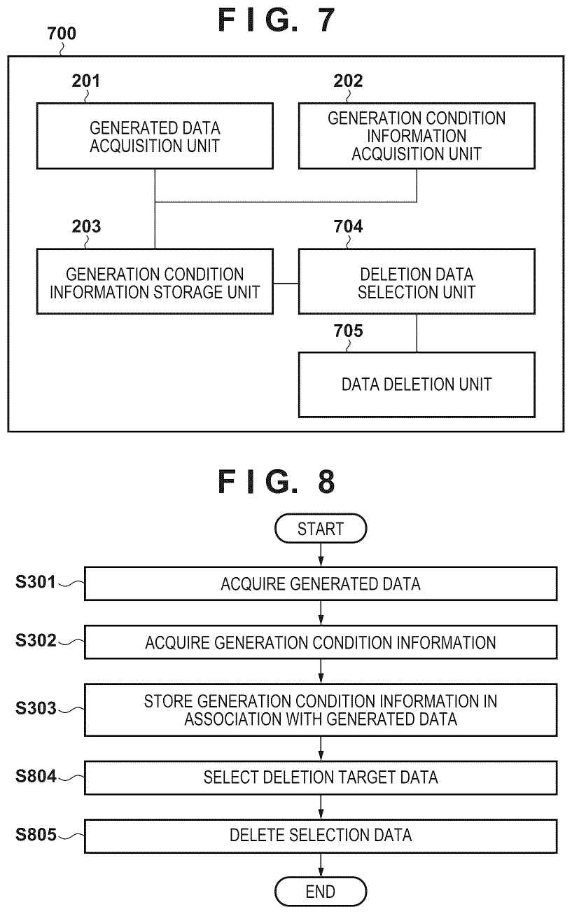

FIG. 7 is a view illustrating a functional configuration example of the information processing apparatus in the present embodiment. An information processing apparatus 700 includes the generated data acquisition unit 201, the generation condition information acquisition unit 202, the generation condition information storage unit 203, a deletion data selection unit 704, and a data deletion unit 705. The same components as the components described in the first embodiment are denoted by identical reference signs, and the description thereof will be omitted.

The deletion data selection unit 704 analyzes the generation condition information stored in the generation condition information storage unit 203, and checks an access history to the generated image. In a case where access is not performed for a certain period or more, the image is selected as an image recommended for deletion.

The data deletion unit 705 deletes the generated image data while retaining only the link to the generation condition information for the image selected by the deletion data selection unit 704.

### Processing

FIG. 8 is a flowchart showing a flow of processing of the information processing apparatus in the present embodiment illustrated in the configuration diagram of FIG. 7. Here, a method of deleting an image will be described.

Steps S301 to S303 are omitted because they are similar to those in the first embodiment. In step S804, by referring to the access history of the supplementary information 401 stored together with the generation condition information for the specific generated image, the deletion data selection unit 704 determines whether or not the generated image is an image with a low use frequency that has not been used for a certain period or more. Then, in a case of an image with a low use frequency that has not been used for a certain period or more, the deletion data selection unit 704 selects the image as deletion target data. That is, the generated data whose use frequency is equal to or less than a threshold is selected as generated data recommended for deletion.

In step S805, the data deletion unit 705 deletes only the generated image data while retaining only the link to the generation condition information for the image file selected in step S804. Here, there are a case where the generation condition information is stored in a file in which the generated image data is stored, and a case where it is stored outside a file such as a cloud or a server.

The flow up to deleting only the generated image data while retaining only the link to the generation condition information has been described above, but the image data may be regenerated based on the generation condition information after deletion. In a case where regeneration is necessary such as a case where a deleted image is an erroneously deleted image, the regeneration can be performed using the configuration described in the second embodiment. Here, differences in regeneration from the second embodiment will be described. In the second embodiment, a partial generation condition of the generation condition information is changed in order to use updated model information description. On the other hand, the present modification is different in use of the same generation condition information.

After the generated data acquisition determination unit 504 determines that regeneration is necessary, the generation condition information transmission unit 505 transmits the generation condition information to the generation apparatus 200 via the communication IF 106. The generation apparatus 200 generates an image by inputting the generation condition information received from the information processing apparatus 500 to the image generation AI held in the generation apparatus 200. The generated data acquisition unit 201 acquires the regenerated data from the generation apparatus 200 via the communication IF 106.

### Effect

As described above, according to the present embodiment, the use capacity of the storage can be reduced.

### Modification: Deleting Image with Low Quality

In the third embodiment, an image with a low use frequency is selected as a deletion target, but an image with low quality may be selected as a deletion target. In that case, the deletion data selection unit 704 acquires the generation condition information from the generated image stored in the ROM 103, and makes a determination based on the prompt and the model identification information. The degree of quality is detected by checking the coincidence degree between the prompt content and the model identification information and the spelling and grammar of the prompt, and in a case where the quality is low, it is selected as a deletion target. That is, the generated data in which the coincidence degree between the prompt and the model identification information is equal to or less than a threshold is selected as generated data recommended for deletion. Alternatively, the degree of quality of the generated data is detected by checking the spelling and grammar of the prompt, and the generated data whose degree of quality is equal to or less than a threshold is selected as generated data recommended for deletion.

This enables the user to reduce the effort of searching for an image with low quality from among the generated images.

### Modification: Deleting Image with Hallucination

In the third embodiment, an image with a low use frequency is selected as a deletion target, but an image including a hallucination may be selected as a deletion target. A hallucination is a phenomenon in which AI generates information that is not based on a fact. In that case, the deletion data selection unit 704 acquires the generation condition information from the generated image stored in the ROM 103, and makes a determination based on the prompt. Whether or not a hallucination exists is detected by checking the coincidence degree between the prompt and a captioning result of the generated image and the matching degree between the content of the generated image and the rule, and in a case where a hallucination exists, it is selected as a deletion target.

This enables the user to reduce the effort of searching for an image in which a hallucination exists from among the generated images.

### Modification: Deleting Image not Generated as Instructed

In the third embodiment, an image with a low use frequency is selected as a deletion target, but an image not generated as instructed may be selected as a deletion target. In that case, the deletion data selection unit 704 acquires the generation condition information from the generated image stored in the ROM 103, and makes a determination based on the prompt. By checking the coincidence degree between the prompt and an object detection result of the generated image, it is detected whether to be not generated as instructed, and in a case of being not generated as instructed, it is selected as a deletion target.

This enables the user to reduce the effort of searching for an image that is not generated as instructed from among the generated images.

### Modification: Deleting Similar Image

In the third embodiment, an image with a low use frequency is selected as a deletion target, but a similar image may be selected as a deletion target. In that case, the deletion data selection unit 704 acquires the generation condition information from the generated image stored in the ROM 103, and makes a determination based on them. Whether or not to be a similar image is detected by checking a similarity value when generated images are compared with each other or whether or not to be images generated under almost the same or exactly the same generation condition, and in a case of being a similar image, it is selected as a deletion target. That is, the similarity between the generated images (generated data) may be calculated and a determination may be made based on the similarity, or the similarity between the generation conditions may be calculated and a determination may be made based on the similarity. Alternatively, these may be combined. Then, in a case of being similar, one of the similar generated images may be selected as a deletion target.

This enables the user to reduce the effort of searching for a similar image from among the generated images.

### Modification: Deleting Intermediate Image in Generation for Plurality of Times

In the third embodiment, an image with a low use frequency is selected as a deletion target, but an intermediate image generated a plurality of times may be selected as a deletion target. The deletion data selection unit 704 acquires the generation condition information from the generated image stored in the ROM 103, and makes a determination based on generation source data information. In a case where the generated image is an image corresponding to an intermediate portion when Image-to-Image is repeated a plurality of times, it is selected as a deletion target.

This enables the user to reduce the effort of searching for an intermediate image generated a plurality of times from among the generated images.

### Modification: Deleting Image Generated with Model of Old Version

In the third embodiment, an image with a low use frequency is selected as a deletion target, but an image generated with a model of an old version may be selected as a deletion target. The deletion data selection unit 704 acquires the generation condition information from the generated image stored in the ROM 103, and makes a determination based on the model identification information. The model identification information is checked, and in a case of being an old version, it is selected as a deletion target.

This enables the user to reduce the effort of searching for an image generated with a model of an old version from among the generated images.

### Modification: Excluding Image with Long Generation Time from Deletion Target

In the third embodiment, an image with a low use frequency is selected as a deletion target, but an image with a long generation time may be excluded from a deletion target. The deletion data selection unit 704 acquires the generation condition information from the generated image stored in the ROM 103, and makes a determination based on the supplementary information 401. In a case where the time required for image generation is equal to or more than the threshold, it is excluded from a deletion target.

This can increase the possibility of excluding, from a deletion target, an image that the user is highly likely not to desire to delete.

### Modification: Excluding Image of Source of Many Generated Images from Deletion Target

In the third embodiment, an image with a low use frequency is selected as a deletion target, but an image that is a source of many generated images may be excluded from a deletion target. The deletion data selection unit 704 acquires the generation condition information from the generated image stored in the ROM 103, and makes a determination based on generation source data information. In a case where the target image is a source image of a predetermined number or more of generated images, it is excluded from a deletion target. That is, control may be performed so that generated data that is source data of a predetermined number or more of generated data is not selected as generated data recommended for deletion.

This can increase the possibility of excluding, from a deletion target, an image that the user is highly likely not to desire to delete.

### Modification: Excluding Image with Large Number of Trials from Deletion Target

In the third embodiment, an image with a low use frequency is selected as a deletion target, but an image with a large number of trials may be excluded from a deletion target. The deletion data selection unit 704 acquires the generation condition information from the generated image stored in the ROM 103, and makes a determination based on the supplementary information 401. In a case where the number of times of generation required for image generation is equal to or more than a threshold, it is excluded from a deletion target. That is, in a case where the number of times of use for image generation is equal to or more than a threshold, it is excluded from a deletion target.

This can increase the possibility of excluding, from a deletion target, an image that the user is highly likely not to desire to delete.

### Modification: Excluding Image Estimated to be Greatly Affected by Model Update from Deletion Target

In the third embodiment, an image with a low use frequency is selected as a deletion target, but an image estimated to be greatly affected by model update may be excluded from a deletion target. The deletion data selection unit 704 acquires the generation condition information from the generated image stored in the ROM 103, and makes a determination based on the model identification information. In a case where a case where a generated image has been considerably changed by past model update is checked, it is excluded from a deletion target.

This can increase the possibility of excluding, from a deletion target, an image that the user is highly likely not to desire to delete.

### Third Embodiment

The present embodiment is a description of a technology that generates a generation history map from a generated image generated in multi-stage. The image generation AI has a method of generation called Image-to-Image in which an image is input to the image generation AI to generate different images. For example, style transfer from an animation image into a photorealistic image corresponds to this. In addition, there is a case of performing alteration by Image-to-Image targeting a partial region of an image. For example, a method of generating or deleting an object in a specific region of an image using an Inpainting technology corresponds to this. The present embodiment assumes a case where multi-stage generation is performed by repeating a plurality of times Image-to-Image in which the entire or a partial region of the image is altered in this manner. In the present embodiment, the generation history map representing the parent-child relationship of an image group generated in multi-stage is generated by using the source image information recorded in the generation condition information.

### Functional Configuration

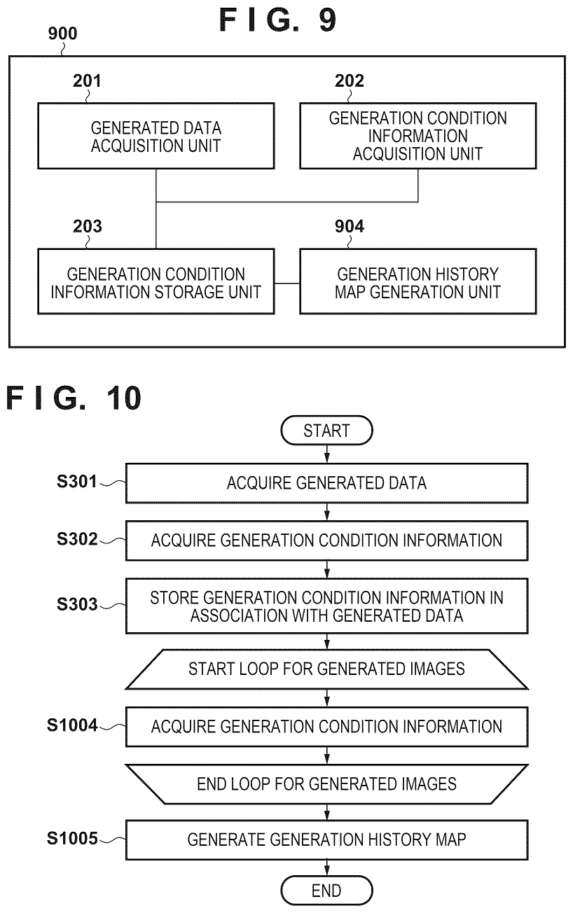

FIG. 9 is a view illustrating a functional configuration example of the information processing apparatus in the present embodiment. An information processing apparatus 900 includes the generated data acquisition unit 201, the generation condition information acquisition unit 202, the generation condition information storage unit 203, and a generation history map generation unit 904. The same components as the components described in the first embodiment are denoted by identical reference signs, and the description thereof will be omitted.

The generation history map generation unit 904 acquires source image information recorded in the generation condition information of a multi-stage generated image stored in the generation condition information storage unit 203, and generates a generation history map based on the source image information. The generation history map is a map representing the parent-child relationship of a generated data group generated in multi-stage.

### Processing

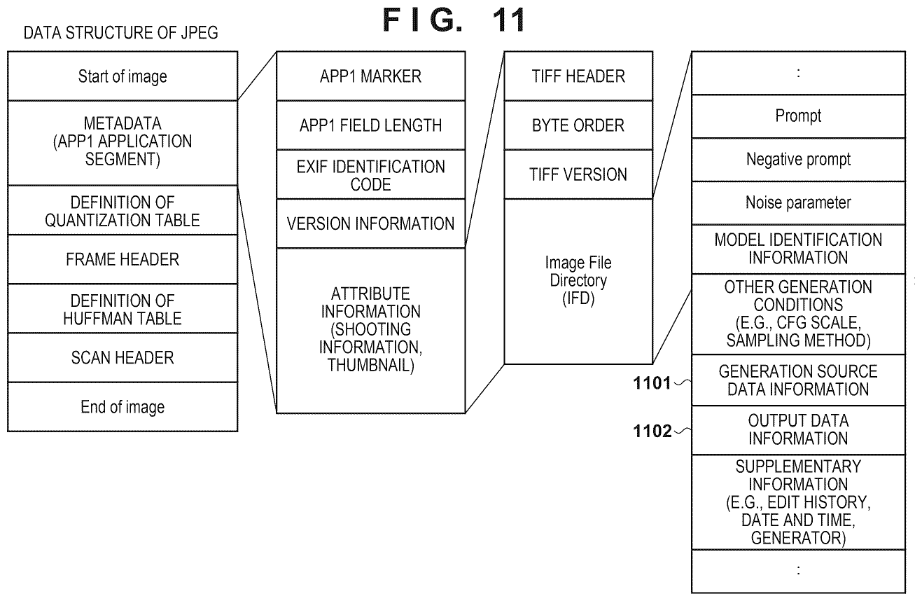

FIG. 10 is a flowchart showing a flow of processing of the information processing apparatus in the present embodiment illustrated in the configuration diagram of FIG. 9. Here, a method of generating the generation history map will be described.

Steps S301 to S303 are omitted because they are similar to those in the first embodiment. In the present embodiment, the generation condition information acquired in step S302 is different in content from the generation condition information acquired in the first to third embodiments. Specifically, from the image generated by Image-to-Image, in addition to the content acquired in the first to third embodiments, information that can identify the image data input to the generative AI is acquired.

In step S1004, the generation history map generation unit 904 acquires generation condition information targeting one of the generated images stored in the ROM 103. Here, FIG. 11 is an example of the data structure of the generation condition information acquired in the fourth embodiment. The data includes generation source data information 1101 for identifying generation source data and output data information 1102 for identifying output destination data, and the parent-child relationship of the data can be ascertained by acquiring them. The processing of the present step is repeated until all the generated images stored in the ROM 103 are processed.

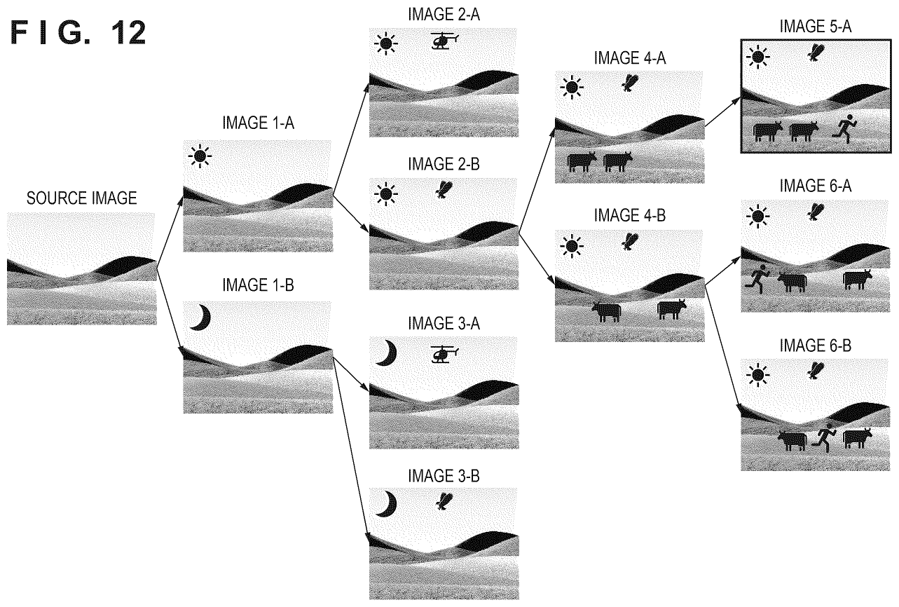

In step S1005, the generation history map generation unit 904 generates a generation history map targeting all the generated images whose generation condition information has been acquired. In the present embodiment, information on the parent-child relationship of the images from the source image to the final generated image recorded in the generation condition information is recursively acquired with the selected image as a starting point. Here, in a case where there is a deleted image, image regeneration is performed based on the third embodiment. Finally, the generation history map is generated based on the acquired image group. Here, FIG. 12 is a display example of the generation history map that is generated. One of the methods of achieving such a display form is a directed graph. A directed graph is created from the parent-child relationship acquired based on each piece of generation condition information, and a generated image is assigned to each node and displayed. In the example of FIG. 12, the source image is branched into an image 1-A and an image 1-B. Then, the image 1-A has child images of an image 2-A and an image 2-B. The image 1-B has child images of an image 3-A and an image 3-B. The image 2-A has no child image, whereas the image 2-B has child images of an image 4-A and an image 4-B. The image 4-A has a child image of an image 5-A. The image 4-B has child images of an image 6-A and an image 6-B.

### Effect

As described above, according to the present embodiment, since the user can check the generation history from the source image to the final generated image on the UI, it is possible to reduce the effort required to check the generation history.

### Modification: Automatic Generation by System

In the fourth embodiment, the generation history map is generated for all the images whose generation condition information has been acquired, but the timing of generating the generation history map may be a timing intended by the user or automatically controlled by the system. For example, based on a time interval set for the system by the user, the generation history map generation unit 904 may perform control so as to generate the generation history map or update the generation history map with respect to the generated image stored in the ROM 103. In addition to this, control may be performed such that the generation history map is generated or the generation history map is updated at the time of login to or logout from the system or in a case where the length of the parent-child relationship becomes equal to or more than a predetermined number.

This enables the user to freely adjust the generation timing of the generation history map.

### Modification: Manual Selection of Image by User

In the fourth embodiment, the generation history map is generated for all the images whose generation condition information has been acquired, but the generation history map may be generated targeting some images selected by the user. The user selects an image for which generation of a generation history map or update of a generation history map is desired from among the generated image group displayed on the display unit 104. The generation history map generation unit 904 generates the generation history map or updates the generation history map for the selected generated image.

This enables the user to create a generation history map or update a generation history map only for a desired generated image.

### Fifth Embodiment

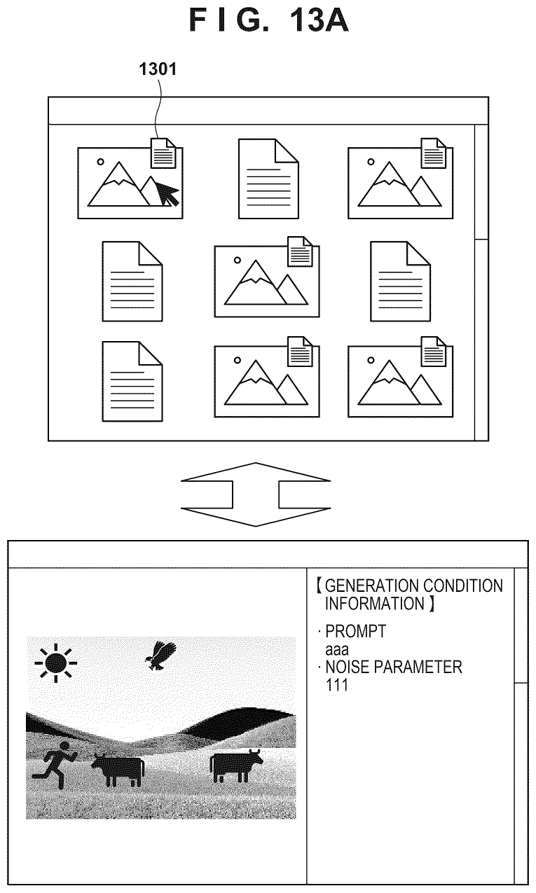

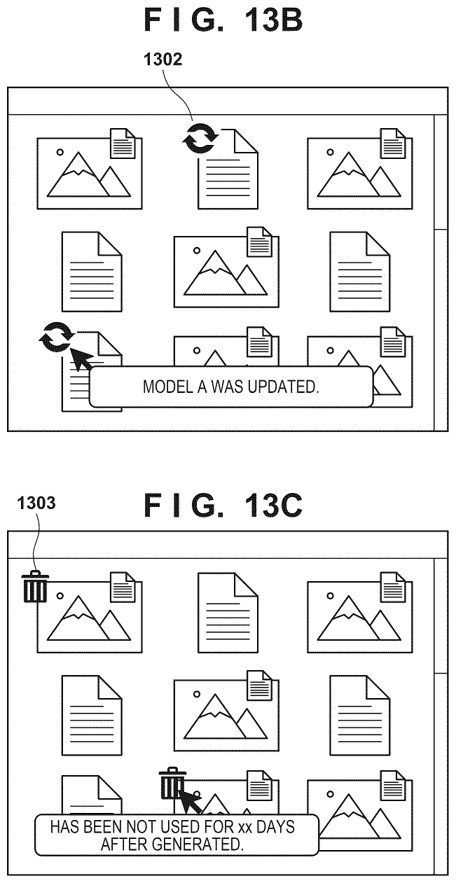

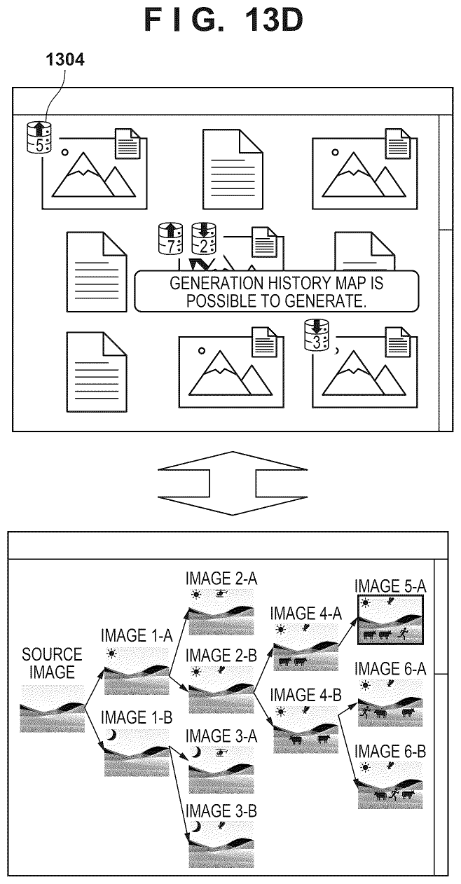

In the present embodiment, a display example of a UI for achieving the first to fourth embodiments will be described. FIG. 13A illustrates an example of a UI in the first embodiment. In this example, an icon of Exif is displayed on a thumbnail image as an icon 1301 in order to indicate that the generated image and Exif in which the generation condition information is recorded are associated with each other. It is also possible to switch the display between the present screen and an UI that displays the generated image and the generation condition information associated with the generated image together. For example, it may be configured to transition to the UI that displays the generated image and the generation condition information associated with the generated image together by pressing the icon 1301.

FIG. 13B illustrates an example of a UI in the second embodiment. In this example, an update icon is displayed on a thumbnail image as an icon 1302 in order to indicate that regeneration is determined to be necessary in the generated image. The image regeneration described in the second embodiment can be performed via this icon 1302. For example, regeneration of the image may be configured to be performed by pressing the icon 1302.

FIG. 13C illustrates an example of a UI in the third embodiment. In this example, a deletion icon is displayed on a thumbnail image as an icon 1303 in order to indicate that deletion is determined to be necessary in the generated image. It is possible to delete the generated image data described in the third embodiment via this icon 1303. For example, it may be configured such that a display prompting checking as to whether or not to delete the image is performed and deletion is executed in response to selection of deletion by the user, by pressing the icon 1303.

FIG. 13D illustrates an example of a UI in the fourth embodiment. In this example, an icon distinguishing between parents and children and indicating how many parents and children are present is displayed on a thumbnail image as an icon 1304 in order to indicate that the generation history map can be generated. This icon includes an upward arrow or a downward arrow and a numerical value. For example, in a case of the upward arrow and the numerical value of 5, this image indicates continuing for five generations to the parent generation side. In a case where an icon with the upward arrow and the numerical value of 7 and an icon with the downward arrow and the numerical value of 2 are both indicated, this image indicates continuing for seven generations on the parent generation side and continuing for two generations on the child generation side.

However, the present disclosure is not limited to this example, and may be configured to have another meaning. For example, in a case of the upward arrow and the numerical value of 5, it may indicate that there are five parent images of this image. Then, in a case where an icon with the upward arrow and the numerical value of 7 and an icon with the downward arrow and the numerical value of 2 are both indicated, this image may indicate that seven parent images exist and two child images exist.

The generation history map described in the fourth embodiment can be generated from this icon 1304, and switching to the UI for displaying the generation history map is also possible. For example, it may be configured to generate the generation history map or switching to the UI for displaying the generation history map may be performed, by pressing the icon 1304.

### Effect

As described above, according to the present embodiment, by the UI for achieving the first to fourth embodiments being provided to the user, the user can achieve the first to fourth embodiments on the UI.

### Sixth Embodiment

The forms of the image data generated using the image generation AI have been considered from the first to fifth embodiments, but the present disclosure is not limited to them as long as the generative AI is in a media format that can be input and output. For example, it may be a text, a moving image, an audio, a 3D model, or the like.

Specific generation condition information to be input to the generative AI exists according to the medium to be generated. Here, specific generation condition information in each medium will be described below. Text generation includes generation condition information such as Top-P, Temperature, and Max Tokens. Moving image generation includes generation condition information such as number of ftames, number of steps, Frames per second, and motion bucket id. Audio generation includes generation condition information such as speaker id and instrumental. 3D model generation includes generation condition information such as elevations deg and azimuths deg.

At least one of these pieces of specific generation condition information and the generation condition information described in the first embodiment is transmitted to the generation apparatus 200 via the communication IF 106 according to the medium to be generated. This enables the generated data acquisition unit 201 to acquire the generated data generated by the generation apparatus 200.

Detailed configurations and processing flows have already been described in the first to fifth embodiments, and therefore omitted.

### Effect

As described above, according to the present embodiment, the user can implement the first to fifth embodiments for media other than an image.

According to the present disclosure, it is possible to reduce effort required for reference to generation condition information when generative AI performs generation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-156834, filed Sep. 10, 2024, which is hereby incorporated by reference herein in its entirety.

What is claimed is:

1. An information processing apparatus comprising:
an acquisition unit configured to acquire generated data generated by using generative AI;
an information acquisition unit configured to acquire generation condition information that is information indicating a generation condition when the generated data is generated; and
a storage unit configured to store the generated data and the generation condition information in association with each other.

2. The information processing apparatus according to claim 1, wherein the storage unit stores the generation condition information in an identical data file to a data file that stores the generated data.

3. The information processing apparatus according to claim 1, wherein the storage unit links the generated data and the generation condition information on another apparatus, and stores the generated data and the generation condition information in different databases from each other.

4. The information processing apparatus according to claim 1, wherein the generation condition information includes at least one of a prompt, a negative prompt, a noise initial value, a CFG scale, a sampling method, a sampling step, and model identification information.

5. The information processing apparatus according to claim 4, wherein the noise initial value is an initial value of a random number parameter given to the generative AI.

6. The information processing apparatus according to claim 1 further comprising:
a determination unit configured to determine whether or not the generated data needs to be acquired again; and
a transmission unit configured to transmit the generation condition information to a generation apparatus configured to perform generation using the generative AI in a case where the determination unit determines that the generated data needs to be acquired again.

7. The information processing apparatus according to claim 6, wherein
the information acquisition unit further acquires model identification information of a model used by the generation apparatus from the generation apparatus, and
the determination unit compares model identification information included in generation condition information of the generated data held by the storage unit with model identification information acquired from the generation apparatus, and determines that the generated data needs to be acquired again in a case where a model of the generation apparatus is updated.

8. The information processing apparatus according to claim 1 further comprising:
a selection unit configured to select generated data recommended for deletion from the generated data held in the storage unit; and
a deletion unit configured to delete the generated data selected by the selection unit while retaining a link to the generation condition information.

9. The information processing apparatus according to claim 8, wherein the selection unit selects generated data whose use frequency is equal to or less than a threshold as the generated data recommended for deletion.

10. The information processing apparatus according to claim 8, wherein
the generation condition information includes a prompt and model identification information, and
the selection unit selects, as the generated data recommended for deletion, generated data in which a coincidence degree between the prompt and the model identification information is equal to or less than a threshold.

11. The information processing apparatus according to claim 8, wherein
the generation condition information includes a prompt, and
the selection unit checks spelling and grammar of the prompt to detect a degree of quality of generated data, and select generated data of which the degree of quality is equal to or less than a threshold as the generated data recommended for deletion.

12. The information processing apparatus according to claim 8, wherein the selection unit selects, as the generated data recommended for deletion, generated data in which a hallucination, which is a phenomenon in which the generative AI generates information not based on a fact, exists.

13. The information processing apparatus according to claim 8, wherein
the generation condition information includes a prompt, and
the selection unit checks a coincidence degree between the prompt and an object detection result of the generated data, and selects, as the generated data recommended for deletion, generated data not generated according to an instruction of the prompt.

14. The information processing apparatus according to claim 8, wherein the selection unit calculates similarity between generated data, and selects, as the generated data recommended for deletion, one of generated data similar to each other.

15. The information processing apparatus according to claim 8, wherein in a case where generated data is an image corresponding to an intermediate portion when Image-to-Image is repeated a plurality of times, the selection unit selects the generated data as the generated data recommended for deletion.

16. The information processing apparatus according to claim 8, wherein
the generation condition information includes model identification information, and
the selection unit selects, as the generated data recommended for deletion, generated data generated with a model of an old version.

17. The information processing apparatus according to claim 8, wherein the selection unit does not select, as the generated data recommended for deletion, generated data whose time required for generation is equal to or more than a threshold.

18. The information processing apparatus according to claim 8, wherein the selection unit does not select, as the generated data recommended for deletion, generated data that is source data of a predetermined number or more of generated data.

19. The information processing apparatus according to claim 1 further comprising a map generation unit configured to generate a generation history map representing a parent-child relationship of a generated data group generated in multi-stage based on the generation condition information.

20. The information processing apparatus according to claim 19 further comprising a display unit configured to display the generation history map.

21. The information processing apparatus according to claim 1 further comprising a display unit configured to display the generated data and the generation condition information.

22. The information processing apparatus according to claim 1, wherein the generated data includes a text, an image, a moving image, an audio, or a 3D model generated by the generative AI.

23. A method of controlling an information processing apparatus, the method comprising:
acquiring generated data generated using generative AI;
acquiring generation condition information that is information indicating a generation condition when the generated data is generated; and
storing the generated data and the generation condition information in association with each other.

24. A non-transitory computer-readable storage medium storing a program for causing a computer to execute a method of controlling an information processing apparatus, the method including:
acquiring generated data generated using generative AI;
acquiring generation condition information that is information indicating a generation condition when the generated data is generated; and
storing the generated data and the generation condition information in association with each other.
